(19) United States
(12) Patent Application Publication
(10) Pub. No.: US 2021/0061351 A1
(43) Pub. Date: Mar. 4, 2021

(54) Connecting mechanism between the karting steering knuckle and the vehicle body

(71) Applicant: Shenzhen Xiaocheshou Technology Co.,Ltd, Shenzhen (CN)

(72) Inventor: Hu Jian, Shenzhen (CN)

(21) Appl. No.: 16/554,667

(22) Filed: Aug. 29, 2019

(51) Int. Cl. B62D 7/08; B62D 7/18; B62D 7/20; B62D 7/22

(52) U.S. Cl. CPC B62D 7/08; B62D 7/228; B62D 7/20; B62D 7/18

(57) ABSTRACT

The invention discloses a connecting mechanism between the karting steering knuckle and the vehicle body, including the steering knuckle support unit. The side of the steering knuckle support unit is provided with the slot and the inside of which is provided with the steering knuckle. The right end of the steering knuckle is provided with the tire and the steering knuckle is connected with the tire in rotation. The rear-end of the steering knuckle is provided with the steering linkage. The upper and lower surface of the steering knuckle support unit are provided with symmetrical kingpin screw holes which are provided with kingpin screw inside. The upper surface of the steering knuckle support unit is provided with the regulating connecting rod joint and the side of the which is provided with the regulating connecting rod. The end of the regulating connecting rod away from the regulating connecting rod joint is connected to the vehicle body. The connection mechanism between the karting steering knuckle and the vehicle body is simple in structure which can make the inclination angle of the kingpin regulating rotation shaft adjustable by regulating the length of the regulating connecting rod, meanwhile, when the steering knuckle is struck by external force, the steering knuckle support unit can bear the direct stress. The steering knuckle support unit can be replaced independently without the trouble of repairing the vehicle body.

### TECHNICAL FIELD

The invention relates to the karting technical field, in particular to a connecting mechanism between karting steering knuckle and vehicle body.

### BACKGROUND ART

In order to reduce cost and simplify structure, many miniaturized special vehicles eliminate complicated suspension system and the steering knuckle is hardwired directly to the vehicle body, for example, the karting. However, for this plan, on the one hand, the inclination angle of steering kingpin can't be adjusted; on the other hand, when the wheel is impacted, the steering knuckle will bear the stress, resulting in the deformation of the vehicle body connected with it, which is difficult to repair.

### CONTENTS OF THE INVENTION

The invention to solve the technical problem is to overcome the existing defects and to provide a connecting mechanism between karting steering knuckle and vehicle body with a simple structure by adjusting the length of the regulating connecting rod to make the inclination angle of the kingpin regulating rotation shaft adjustable, meanwhile, when the steering knuckle is struck by external force, the steering knuckle support unit can bear the direct stress. The steering knuckle support unit can be replaced independently without the trouble of repairing the vehicle body, which can effectively solve the problem in the Background Art.

To achieve the above purposes, the invention provides the following technical plan: A connecting mechanism between the karting steering knuckle and the vehicle body, including the steering knuckle support unit. The side of the steering knuckle support unit is provided with the slot and the inside of the slot is provided with the steering knuckle. The right end of the steering knuckle is provided with the tire and the steering knuckle is connected with the tire in rotation. The rear-end of the steering knuckle is provided with the steering linkage. The upper and lower surface of the steering knuckle support unit are provided with symmetrical kingpin screw holes which are provided with kingpin screw inside. The upper surface of the steering knuckle support unit is provided with the regulating connecting rod joint and the side of the regulating connecting rod joint is provided with the regulating connecting rod. The end of the regulating connecting rod away from the regulating connecting rod joint is connected to the vehicle body. The center of the left side of the steering knuckle support unit is provided with the kingpin regulating rotation shaft, the left side of the kingpin regulating rotation shaft is provided with the fixed screw hole and the internal thread of the fixed screw hole is connected with the fixed screw. The side of the kingpin regulating rotation shaft is provided with the metal sleeve, the kingpin regulating rotation shaft is fixed and connected with the metal sleeve through the fixed screw and the metal sleeve is fixed and connected with the vehicle body.

As an optimal technical plan of the invention, the connection between the regulating connecting rod and the regulating connecting rod joint is provided with the second universal joint and the regulating connecting rod is connected with the regulating connecting rod joint through the second universal joint.

As an optimal technical plan of the invention, the connection between the regulating connecting rod and the vehicle body is provided with the third universal joint and the regulating connecting rod is connected with the vehicle body through the third universal joint.

As an optimal technical plan of the invention, the connection between the steering linkage and the steering knuckle is provided with the first universal joint and the steering linkage is connected with the steering knuckle through the first universal joint.

As an optimal technical plan of the invention, the middle part of the steering knuckle is in the interior of the slot, the middle part of the upper surface of the steering knuckle corresponding to the kingpin screw is provided with the steering knuckle screw hole and the kingpin screw is connected with the thread of the steering knuckle screw hole.

Compared with prior art, the invention has the following beneficial effects: The connection mechanism between the karting steering knuckle and the vehicle body allows the inclination angle between the regulating connecting rod and the regulating connecting rod joint to be adjusted so as to facilitate the steering adjustment of the steering knuckle support unit, allows the inclination angle between the regulating connecting rod and the vehicle body to be adjusted so as to facilitate the steering adjustment of the steering knuckle support unit and to facilitate the adjustment of the steering knuckle support unit through the steering linkage, fixes and connects the steering knuckle support unit and the steering knuckle so as to facilitate the steering adjustment of the vehicle body. The whole connection mechanism is simple in structure which can make the inclination angle of the kingpin regulating rotation shaft adjustable by adjusting the length of the regulating connecting rod, meanwhile, when the steering knuckle is struck by external force, the steering knuckle support unit can bear the direct stress. The steering knuckle support unit can be replaced independently without the trouble of repairing the vehicle body.

### DESCRIPTION OF FIGURES

FIG. 1 is the schematic diagram of the structure of the invention.

In this FIGURE: 1 Steering knuckle support unit, 2 Slot, 3 Kingpin screw, 4 Steering knuckle, 5 Tire, 6 First universal joint, 7 Steering linkage, 8 Kingpin regulating rotation shaft, 9 Fixed screw hole, 10 Metal sleeve, 11 Vehicle body, 12 Fixed screw, 13 Regulating connecting rod joint, 14 Regulating connecting rod 15 Second universal joint, 16 Third universal joint.

### MODE OF CARRYING OUT THE INVENTION

The technical plan in the embodiments of the invention is described clearly and completely in combination with the attached drawings of the embodiments of the invention. It is evident that the embodiments described are only a part of the embodiments of the invention and not all of them. Based on the embodiments of the invention, all other embodiments obtained by ordinary technicians in the field without making creative work are within the scope of protection of the invention.

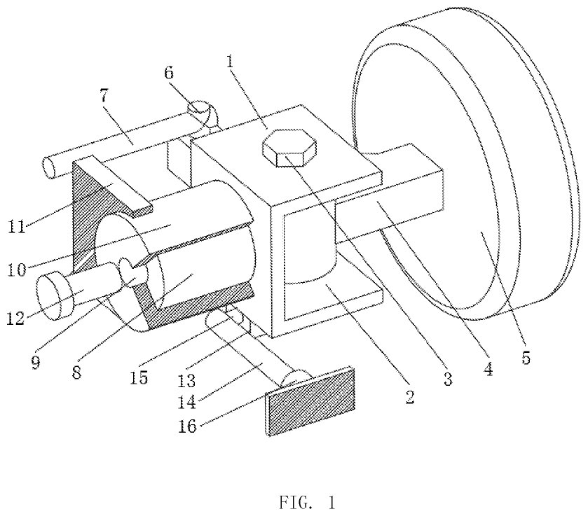

Please make reference to FIG. 1, the invention provides the following technical plan: A connecting mechanism between the karting steering knuckle and the vehicle body, including the steering knuckle support unit (1), characterized in that the side of the steering knuckle support unit (1) is provided with the slot (2) and the inside of the slot (2) is provided with the steering knuckle (4) as the steering device. The right end of the steering knuckle (4) is provided with the tire (5) and the steering knuckle (4) is connected with the tire (5) in rotation. The rear-end of the steering knuckle (4) is provided with the steering linkage (7). The connection between the steering linkage (7) and the steering knuckle (4) is provided with the first universal joint (6) and the steering linkage (7) is connected with the steering knuckle (4) through the first universal joint (6) so as to facilitate the adjustment of steering knuckle support unit (1) through the steering linkage (7). The upper and lower surface of the steering knuckle support unit (1) are provided with symmetrical kingpin screw holes which are provided with kingpin screw (3) inside. The middle part of the steering knuckle (4) is in the interior of the slot (2), the middle part of the upper surface of the steering knuckle (4) corresponding to the kingpin screw (3) is provided with the steering knuckle screw hole and the kingpin screw (3) is connected with the thread of the steering knuckle screw hole. To fixe and connect the steering knuckle support unit (1) and the steering knuckle (4) can facilitate the steering adjustment of the vehicle body (11). The upper surface of the steering knuckle support unit (1) is provided with the regulating connecting rod joint (13) and the side of the regulating connecting rod joint (13) is provided with the regulating connecting rod (14) which is in telescopic structure. The end of the regulating connecting rod (14) away from the regulating connecting rod joint (13) is connected to the vehicle body (11). The connection between the regulating connecting rod (14) and the regulating connecting rod joint (13) is provided with the second universal joint (15) and the regulating connecting rod (14) is connected with the regulating connecting rod joint (13) through the second universal joint (15) to allow the inclination angle between the regulating connecting rod (14) and the regulating connecting rod joint (13) to be adjusted so as to facilitate the steering adjustment of the steering knuckle support unit (1). The connection between the regulating connecting rod (14) and the vehicle body (11) is provided with the third universal joint (16) and the regulating connecting rod (14) is connected with the vehicle body (11) through the third universal joint (16) to allow the inclination angle between the regulating connecting rod (14) and the vehicle body (11) to be adjusted so as to facilitate the steering adjustment of the steering knuckle support unit (1). The center of the left side of the steering knuckle support unit (1) is provided with the kingpin regulating rotation shaft (8), the left side of the kingpin regulating rotation shaft (8) is provided with the fixed screw hole (9) and the internal thread of the fixed screw hole (9) is connected with the fixed screw (12). The side of the kingpin regulating rotation shaft (8) is provided with the metal sleeve (10) and the kingpin regulating rotation shaft (8) is fixed and connected with the metal sleeve (10) through the fixed screw (12) to make the steering knuckle support unit (1) removable so as to facilitate the replacement of the steering knuckle support unit (1). The metal sleeve (10) is fixed and connected with the vehicle body (11). By adjusting the length of the regulating connecting rod (14), the regulating connecting rod (14) drives steering knuckle support unit (1) to rotate through regulating connecting rod joint (13) and the steering knuckle support unit (1) drives the kingpin regulating rotation shaft (8) to rotate so as to change the inclination angle of the kingpin regulating rotation shaft (8) and to achieve the regulation of the traditional karting kingpin. When the vehicle body (11) is struck by external force, the steering knuckle support unit (1) can bear the direct stress so as to reduce the force on the vehicle body (11). When the steering knuckle support unit (1) is damaged, it can be replaced directly. The whole connection mechanism is simple in structure which can make the inclination angle of the kingpin regulating rotation shaft (8) adjustable by adjusting the length of the regulating connecting rod (14), meanwhile, when the steering knuckle (4) is struck by external force, the steering knuckle support unit (1) can bear the direct stress. The steering knuckle support unit (1) can be replaced independently without the trouble of repairing the vehicle body.

When using: By adjusting the length of the regulating connecting rod (14), the regulating connecting rod (14) drives steering knuckle support unit (1) to rotate through regulating connecting rod joint (13) and the steering knuckle support unit (1) drives the kingpin regulating rotation shaft (8) to rotate so as to change the inclination angle of the kingpin regulating rotation shaft (8) and to achieve the regulation of the traditional karting kingpin. When the vehicle body (11) is struck by external force, the steering knuckle support unit (1) can bear the direct stress so as to reduce the force on the vehicle body (11). When the steering knuckle support unit (1) is damaged, it can be replaced directly.

The invention allows the inclination angle between the regulating connecting rod (14) and the regulating connecting rod joint (13) to be adjusted so as to facilitate the steering adjustment of the steering knuckle support unit (1); allows the inclination angle between the regulating connecting rod (14) and the vehicle body (11) to be adjusted so as to facilitate the steering adjustment of the steering knuckle support unit (1) and to facilitate the adjustment of the steering knuckle support unit (1) through the steering linkage (7); fixes and connects the steering knuckle support unit (1) and the steering knuckle (4) so as to facilitate the steering adjustment of the vehicle body (11). The whole connection mechanism is simple in structure which can make the inclination angle of the kingpin regulating rotation shaft (8) adjustable by adjusting the length of the regulating connecting rod (14), meanwhile, when the steering knuckle (4) is struck by external force, the steering knuckle support unit (1) can bear the direct stress. The steering knuckle support unit (1) can be replaced independently without the trouble of repairing the vehicle body.

Although the embodiments of the invention have been shown and described, it is possible for ordinary technicians in this field to change, modify, replace and vary these embodiments in various ways without breaking away from the principles and spirit of the invention and the scope of the invention is limited by the attached claims and their equivalents.

1. A connecting mechanism between the karting steering knuckle and the vehicle body, including the steering knuckle support unit (1), characterized in that: The side of the steering knuckle support unit (1) is provided with the slot (2) and the inside of the slot (2) is provided with the steering knuckle (4). The right end of the steering knuckle (4) is provided with the tire (5) and the steering knuckle (4) is connected with the tire (5) in rotation. The rear-end of the steering knuckle (4) is provided with the steering linkage (7). The upper and lower surface of the steering knuckle support unit (1) are provided with symmetrical kingpin screw holes which are provided with kingpin screw (3) inside. The upper surface of the steering knuckle support unit (1) is provided with the regulating connecting rod joint (13) and the side of the regulating connecting rod joint (13) is provided with the regulating connecting rod (14). The end of the regulating connecting rod (14) away from the regulating connecting rod joint (13) is connected to the vehicle body (11). The center of the left side of the steering knuckle support unit (1) is provided with the kingpin regulating rotation shaft (8), the left side of the kingpin regulating rotation shaft (8) is provided with the fixed screw hole (9) and the internal thread of the fixed screw hole (9) is connected with the fixed screw (12). The side of the kingpin regulating rotation shaft (8) is provided with the metal sleeve (10), the kingpin regulating rotation shaft (8) is fixed and connected with the metal sleeve (10) through the fixed screw (12) and the metal sleeve (10) is fixed and connected with the vehicle body (11).

2. A connecting mechanism between the karting steering knuckle and the vehicle body as claimed in claim 1 characterized in that: The connection between the regulating connecting rod (14) and the regulating connecting rod joint (13) is provided with the second universal joint (15) and the regulating connecting rod (14) is connected with the regulating connecting rod joint (13) through the second universal joint (15).

3. A connecting mechanism between the karting steering knuckle and the vehicle body as claimed in claim 1 characterized in that: The connection between the regulating connecting rod (14) and the vehicle body (11) is provided with the third universal joint (16) and the regulating connecting rod (14) is connected with the vehicle body (11) through the third universal joint (16).

4. A connecting mechanism between the karting steering knuckle and the vehicle body as claimed in claim 1 characterized in that: The connection between the steering linkage (7) and the steering knuckle (4) is provided with the first universal joint (6) and the steering linkage (7) is connected with the steering knuckle (4) through the first universal joint (6).

5. A connecting mechanism between the karting steering knuckle and the vehicle body as claimed in claim 1 characterized in that: The middle part of the steering knuckle (4) is in the interior of the slot (2), the middle part of the upper surface of the steering knuckle (4) corresponding to the kingpin screw (3) is provided with the steering knuckle screw hole and the kingpin screw (3) is connected with the thread of the steering knuckle screw hole.
